(19) United States
(12) Patent Application Publication
(10) Pub. No.: US 2008/0267545 A1
(43) Pub. Date: Oct. 30, 2008

(54) HYDRODYNAMIC BEARING ASSEMBLY

(75) Inventors: WUN-CHANG SHIH, Tu-Cheng (TW); QIANG ZHANG, Shenzhen (CN); RUI-JUN HUANG, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignee: FOXCONN TECHNOLOGY CO., LTD., Tu-Cheng (TW)

(21) Appl. No.: 11/762,977

(22) Filed: Jun. 14, 2007

(30) Foreign Application Priority Data
Apr. 25, 2007 (CN) 200710074209.2

(51) Int. Cl. F16C 32/06; H02K 7/08; H02K 9/06

(52) U.S. Cl. 384/117; 310/62; 310/90

(57) ABSTRACT

A hydrodynamic bearing assembly includes a bearing (10) with at least an end thereof being opened and a shaft (38) rotatably disposed in the bearing. A bearing clearance is formed between an outer surface of the shaft and an inner surface of the bearing and is filled with lubricant. A plurality of lubricant pressure generating grooves (14) are axially set on at least one of the inner surface of the bearing and the outer surface of the shaft. Each of the lubricant pressure generating grooves includes two symmetrical branches (141, 142) and has a V-shaped cross section.

### BACKGROUND OF THE INVENTION

1. Field of the Invention

The present invention relates generally to bearing assemblies, and more particularly to a bearing assembly of hydrodynamic type.

2. Description of Related Art

Due to the ever growing demand for quiet, low-friction rotational elements with extended lifetimes, hydrodynamic bearing assemblies have become increasingly used in conventional motors such as fan motors or HDD (hard disk drive) motors.

A typical hydrodynamic bearing assembly comprises a bearing which defines a bearing hole therein, and a shaft rotatably received in the bearing hole with a bearing clearance formed between an inner surface of the bearing and an outer surface of the shaft. The bearing clearance is filled with lubricant. Hydrolubricant pressure generating grooves of so-called herringbone type are provided in either the inner surface of the bearing or the outer surface of the shaft. Each groove has first and second branches extend along different directions from ends of the bearing toward central areas thereof. The first branches and respective second branches intercross at the central areas of the grooves. Once the rotary shaft rotates, the lubricant is driven from the ends of the bearing toward the central areas to generate hydrodynamic pressure, which supports the shaft without direct contact between the shaft and the bearing.

In manufacturing the grooves, a tooling head is needed to extend into the bearing hole to carve the grooves on the inner surface of the bearing. However, the first and second branches of the herringbone type grooves extend along different directions. So the direction of the tooling head needs to be changed during manufacture of the grooves, which is difficult to do due to the small size of the bearing. This makes the grooves complicated to manufacture. So, there is a need for a hydrodynamic bearing assembly with grooves, which can easily be manufactured and can generate satisfactory amounts of hydrodynamic pressure.

### SUMMARY OF THE INVENTION

The present invention relates to a hydrodynamic bearing assembly for a motor such as a fan motor or a HDD motor. According to a preferred embodiment of the present invention, the hydrodynamic bearing assembly includes a bearing with at least an end thereof being opened and a shaft rotatably disposed in the open end of the bearing. A bearing clearance is formed between an outer surface of the shaft and an inner surface of the bearing and is filled with lubricant. A plurality of lubricant pressure generating grooves are axially set on at least one of the inner surface of the bearing and the outer surface of the shaft. Each of the lubricant pressure generating grooves includes two symmetrical surfaces and has a V-shaped cross section.

Other advantages and novel features of the present invention will become more apparent from the following detailed description of preferred embodiment when taken in conjunction with the accompanying drawings, in which:

### BRIEF DESCRIPTION OF THE DRAWINGS

Many aspects of the present hydrodynamic bearing assembly can be better understood with reference to the following drawings. The components in the drawings are not necessarily drawn to scale, the emphasis instead being placed upon clearly illustrating the principles of the present hydrodynamic bearing assembly. Moreover, in the drawings, like reference numerals designate corresponding parts throughout the several views.

FIG. 1 is an isometric, explored view of a cooling fan employing a hydrodynamic bearing assembly according to a preferred embodiment of the present invention;

FIG. 2 is an assembled view of the cooling fan in FIG. 1;

FIG. 3 is a cross sectional view of the cooling fan taken along line II-II of FIG. 2;

FIG. 4 is an isometric, enlarged view of a bearing of the hydrodynamic bearing assembly in FIG. 1;

FIG. 5 is a top view of the bearing in FIG. 4;

FIG. 6 is an isometric view of a shaft of the hydrodynamic bearing assembly according to an alternative embodiment of the present invention; and

FIG. 7 is a cross sectional view of the shaft taken along line VII-VII of FIG. 6.

### DETAILED DESCRIPTION OF THE INVENTION

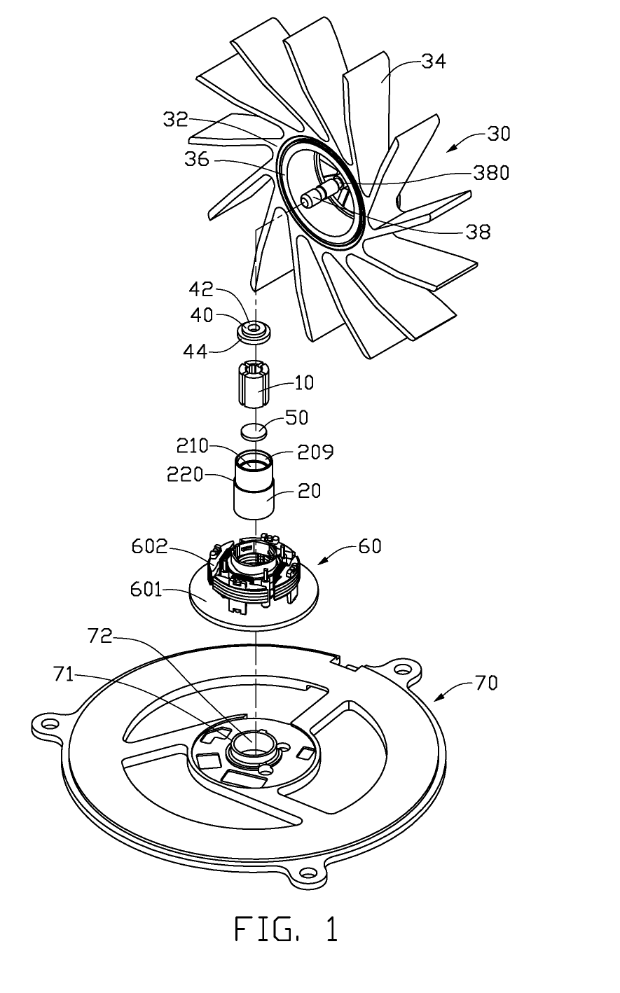

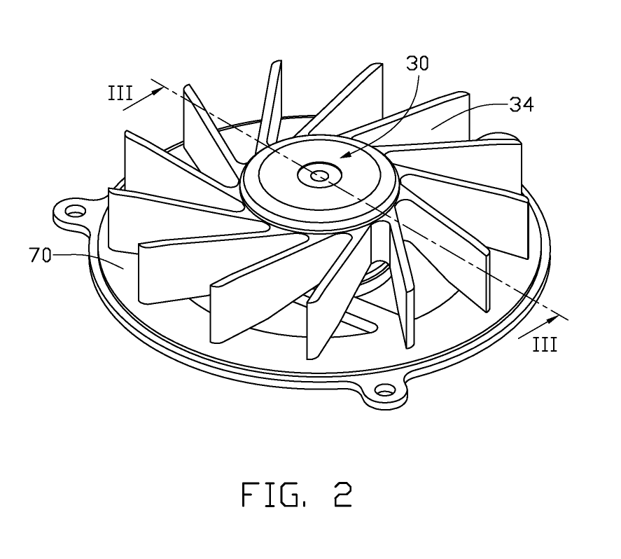

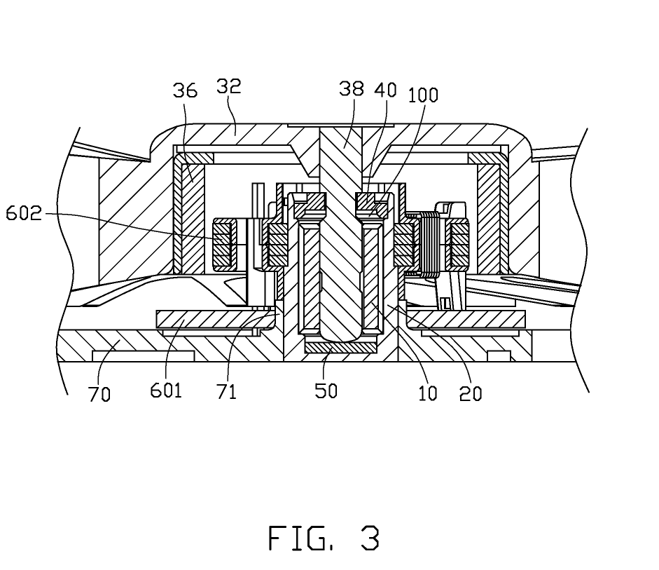

Referring to FIGS. 1 through 3, a hydrodynamic bearing assembly according to a preferred embodiment of the present invention is shown. In this embodiment, the hydrodynamic bearing assembly is used in a cooling fan. Alternatively, the hydrodynamic bearing assembly can be used in other type fan motors or HDD (hard disk drive) motors. The cooling fan further includes a base 70, a sleeve 20, a stator 60, and a rotor 30. The hydrodynamic bearing assembly is mounted in the sleeve 20 for supporting rotation of the rotor 30.

The base 70 has a central tube 71 extending upwardly therefrom and defining a through hole 72 therein. Two opposite ends (i.e., top and bottom ends) of the central tube 71 are open. The sleeve 20 is received in the central tube 71. The sleeve 20 is U-shaped with a bottom end thereof being closed and a top end being open. An inner hole 210 is defined in the sleeve 20 for receiving the hydrodynamic bearing assembly therein. A counter plate 50 made of high abrasion-resistant material is arranged in the bottom end of the sleeve 20. The sleeve 20 defines an end opening 209 at the top end thereof. The end opening 209 has a diameter larger than that of the inner hole 210 of the sleeve 20 and communicates with the inner hole 210 of the sleeve 20. The sleeve 20 forms a step 220 in an outer surface thereof for mounting the stator 60. An outer diameter of an upper portion (not labeled) of the sleeve 20 is smaller than that of a lower portion (not labeled) of the sleeve 20 due to the formation of the step 220.

The stator 60 is mounted around the sleeve 20. The stator 60 includes a stator core 602 with stator coils (not labeled) wound thereon to establish an alternating magnetic field, and a PCB 601 (printed circuit board) being electrically connected with the stator coils (not labeled) of the stator core 602. The PCB 601 has an inner diameter approximately the same as an outer diameter of the central tube 71, and is fixed to an outer surface of the central tube 71. The stator core 602 has an inner diameter approximately the same as the outer diameter of the upper portion (not labeled) of the sleeve 20 and thus is arranged on the step 220 of the sleeve 20. The rotor 30 includes a hub 32 with a plurality of fan blades 34 extending radially and outwardly therefrom, and a magnet 36 attached to an inner surface of the hub 32. The magnet 36 faces the stator core 602 of the stator 60.

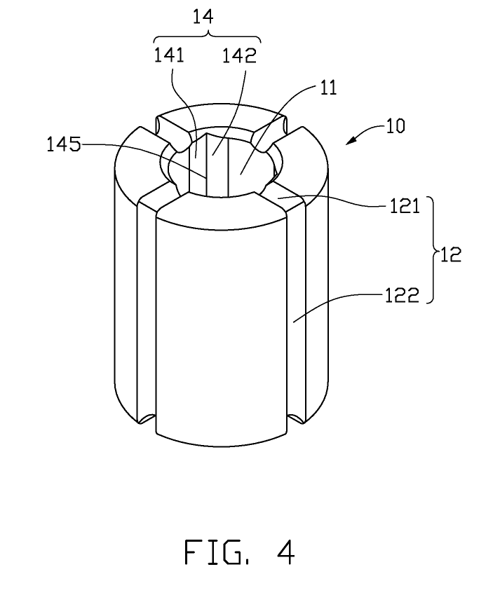

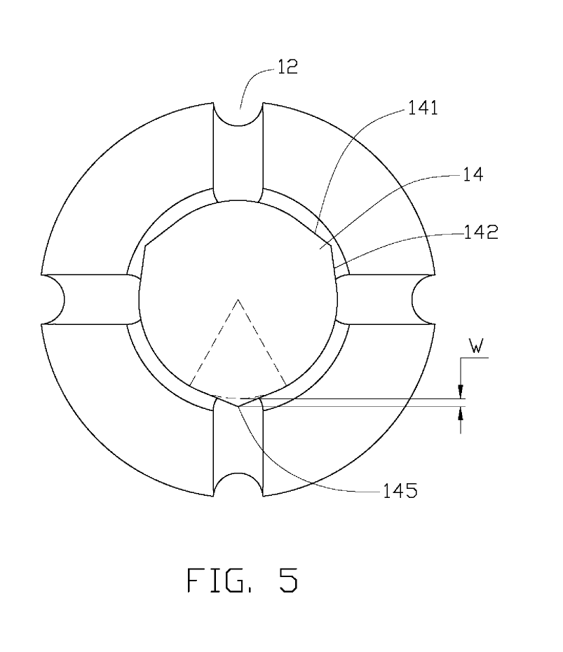

Referring to FIGS. 4-5, the hydrodynamic bearing assembly is received in the inner hole 210 of the sleeve 20, and includes a bearing 10 defining a bearing hole 11 therein and a shaft 38 extending downwardly from a central portion of the hub 32. The shaft 38 is rotatably received in the bearing hole 11 with a bearing clearance formed between an inner surface of the bearing 10 and an outer surface of the shaft 38. The bearing clearance is filled with lubricant. The shaft 38 defines an annular slot 380 in the outer surface thereof, near a top end adjacent to the hub 32. A plurality of channels 12 are defined in an outer surface of the bearing 10. The channels 12 communicate with the bearing hole 11 for flowing back of the lubricant. Each of the channels 12 includes a first portion 121 defined in a top and a bottom end surfaces of the bearing 10 and a second portion 122 defined in an outer surface of the bearing 10. In this embodiment, the bearing 10 defines four channels 12 being evenly distributed around a periphery of the outer surface of the bearing 10.

The bearing 10 defines a plurality of lubricant pressure generating grooves 14 in the inner surface thereof. The lubricant pressure generating grooves 14 extend through the bearing 10 along an axial direction thereof. In this embodiment, the bearing 10 has four lubricant pressure generating grooves 14, which are evenly distributed around a periphery of the inner surface of the bearing 10. The four lubricant pressure generating grooves 14 are located corresponding to the four channels 12 and each lubricant pressure generating groove 14 communicates with a corresponding channel 12. It is to be understood that the number of the lubricant pressure generating grooves 14 is neither limited to be the same as that of the channels 12 nor limited to being four in number.

Particularly referring to FIG. 5, a top view of the bearing 10 is shown. In order to show the lubricant pressure generating grooves 14 of the bearing 10 clearly, the lubricant filling the bearing clearance is removed. Each of lubricant pressure generating grooves 14 is V-shaped, and has first and second branches 141, 142 formed symmetrical to each other. The branches 141, 142 are linear, and have outer edges thereof connecting with the inner surface of the bearing 10. Alternatively, the branches 141, 142 of the lubricant pressure generating groove 14 can be arc-shaped. The two branches 141, 142 of each lubricant pressure generating groove 14 intercross with each other at a midline 145 which is parallel to a central axis of the bearing 10. The two branches 141, 142 of each lubricant pressure generating groove 14 extend from the midline 145 oppositely generally along a circumferential direction of the bearing 10. A radial distance between each lubricant pressure generating groove 14 and the central axis of the bearing 10 is gradually decreased from the midline 145 to a corresponding outer edge of each branch 141 (142) of the lubricant pressure generating groove 14. In other words, the lubricant pressure generating groove 14 has a maximum W depth at the midline 145, and the depth of the lubricant pressure generating groove 14 gradually decreases to the outer edges. For generating satisfied hydrodynamic pressure, the maximum depth W of the lubricant pressure generating grooves 14 is in an approximate range from 0.06 mm to 0.1 mm.

During assembly, the stator 60 is mounted around the sleeve 20. The hydrodynamic bearing assembly is received in the sleeve 20. The bearing 10 is lower than the end opening 209 of the sleeve 20. The counter plate 50 faces and supportively engages a free end of the shaft 38. The rotor 30 is fixedly assembled with the top end of the shaft 38 of the hydrodynamic bearing assembly. An oil-retaining cover 40 is mounted in the end opening 209 of the sleeve 20. The cover 40 has an upper portion 42 with an inner diameter approximately the same as a diameter of a portion of the shaft 38 defining the slot 380, and a lower portion 44 with an inner diameter larger than the diameter of the shaft 38. The upper portion 42 of the cover 40 is mounted around and received in the slot 380 of the shaft 38, and the lower portion 44 of the cover 40 is arranged on the top end and received in the end opening 209 of the sleeve 20. An oil-retaining space 100 is thus formed among the sleeve 20, the shaft 38, the top end of the bearing 10 and the cover 40 for receiving lubricant. During operation, the rotor 30 is driven to rotate by the interaction of the alternating magnetic field established by the stator 60 and the magnetic field of the rotor 30. The lubricant is driven from the top and bottom ends of the bearing 10 toward the central areas to generate hydrodynamic pressure, which supports the shaft 38 without direct contact between the shaft 38 and the bearing 10. When lubricant creeps up along the rotating shaft 38 under the influence of the centrifugal force generated by the rotation of the shaft 38, the oil-retaining cover 40 can sufficiently prevent the oil from leaking out of the hydrodynamic bearing assembly. Thus the escaping oil is received in the space 100 and then flows back to the bearing hole 11 of the bearing 10 via the bottom end surface of the bearing 10 through the channels 12 of the bearing 10. Therefore the oil can be kept from leaking out of the bearing 10. Good hydrodynamic pressure of the bearing 10 and shaft 18 is thus consistently maintained.

In the present invention, the lubricant pressure generating grooves 14 extend along the axial direction of the bearing 10. So the direction of a tooling head may not be changed during the manufacturing of the lubricant pressure generating grooves 14. This allows the lubricant pressure generating grooves 14 to be simply carved onto the inner surface of the bearing 10 as compared to the manufacture of the herringbone shaped lubricant pressure generating grooves 14. Moreover, the lubricant pressure generating groove 14 is symmetrical, which makes the hydrodynamic bearing assembly easier to assemble, because either the first branch 141 or the second branch 142 of each lubricant pressure generating groove 14 can generate hydrodynamic pressure to support rotation of the shaft 38 no matter whether the shaft 38 is rotating clockwise or anti-clockwise. In other words, the bearing 10 can be mounted into the sleeve 20 with no direction limitation which is usually exists in the fan of asymmetrical lubricant pressure generating grooves having mounting directions relative to the rotation direction thereof, and thus assembly of the bearing 10 is made easier.

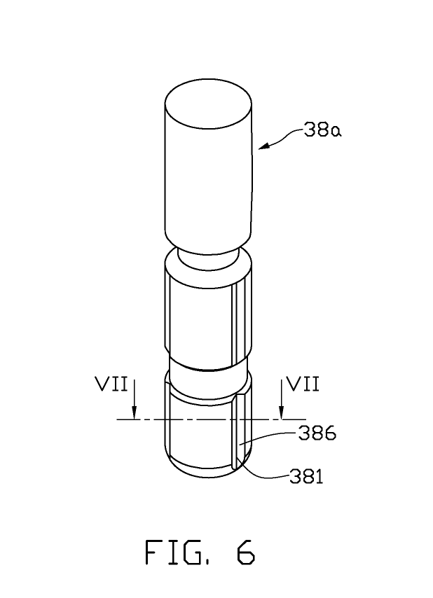

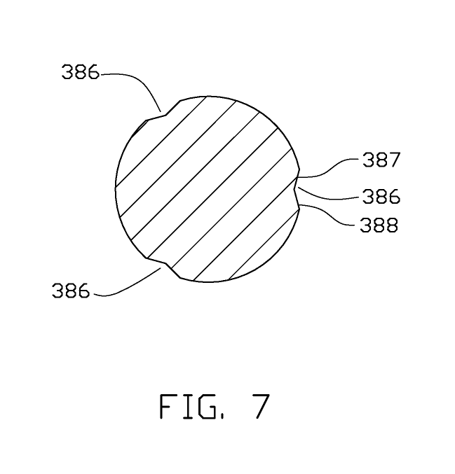

FIGS. 6-7 show an alternative embodiment of the bearing assembly. In this embodiment, the lubricant pressure generating grooves 386 are defined in the outer surface of the shaft 38a. As the lubricant pressure generating grooves 14 formed on the bearing 10 of the previous embodiment, each of the lubricant pressure generating grooves 386 of the shaft 38a has two symmetrical branches 387, 388. The two branches 387, 388 of each lubricant pressure generating groove 386 intercross at the midline 381. A depth of each lubricant pressure generating groove 386 is gradually decreased from the midline 381 to the outer edge of each branch 387, 388.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A hydrodynamic bearing assembly comprising:
a bearing with at least an end thereof being opened;
a shaft being rotatably disposed in the bearing;
lubricant contained in a bearing clearance formed between an outer surface of the shaft and an inner surface of the bearing; and
a plurality of lubricant pressure generating grooves being axially set on at least one of the inner surface of the bearing and the outer surface of the shaft, each of the lubricant pressure generating grooves comprising two symmetrical branches and having a V-shaped cross section.

2. The hydrodynamic bearing assembly of claim 1, wherein the lubricant pressure generating grooves are evenly distributed around and extend through the at least one of the inner surface of the bearing and the outer surface of the shaft.

3. The hydrodynamic bearing assembly of claim 1, wherein the two branches of each lubricant pressure generating groove are one of linear shaped and arc shaped, and outer edges of the two branches connect with the at least one of the inner surface of the bearing and the outer surface of the shaft.

4. The hydrodynamic bearing assembly of claim 1, wherein the two branches of each lubricant pressure generating groove intercross with each other at a midline parallel to a central axis of the hydrodynamic bearing assembly, and the lubricant pressure generating groove has a depth gradually decreased from the midline to an outer edge of each of the two branches.

5. The hydrodynamic bearing assembly of claim 4, wherein a maximum depth of each of the lubricant pressure generating grooves is in an approximate range from 0.06 to 0.1 mm.

6. The hydrodynamic bearing assembly of claim 1, wherein the lubricant pressure generating grooves are formed in the inner surface of the bearing, and the bearing defines a plurality of channels in an outer surface for flowing back of the lubricant, each channel communicating with a corresponding lubricant pressure generating groove.

7. A cooling fan comprising:
a base;
a sleeve projecting upwardly from the base and defining an inner hole therein;
a stator mounted around the sleeve;
a hydrodynamic bearing assembly received in the inner hole of the sleeve, the hydrodynamic bearing assembly comprising a bearing and a shaft being rotatably disposed in the bearing, a plurality of lubricant pressure generating grooves being axially set on at least one of an inner surface of the bearing and an outer surface of the shaft, each of the lubricant pressure generating grooves comprising two symmetrical branches and substantially having a V-shaped cross section; and
a rotor having a plurality of fan blades being fixedly connected to the shaft.

8. The cooling fan of claim 7, wherein the lubricant pressure generating grooves are evenly distributed around and extend through the at least one of the inner surface of the bearing and the outer surface of the shaft.

9. The cooling fan of claim 7, wherein the two branches of each lubricant pressure generating groove are one of linear shaped and arc shaped, and outer edges of the two branches connect with the at least one of the inner surface of the bearing and the outer surface of the shaft.

10. The cooling fan of claim 7, wherein the two branches of each lubricant pressure generating groove intercross with each other at a midline parallel to a central axis of the hydrodynamic bearing assembly, and the lubricant pressure generating groove has a depth gradually decreased from the midline to an outer edge of each of the two branches.

11. The cooling fan of claim 10, wherein a maximum depth of each of the lubricant pressure generating grooves is in an approximate range from 0.06 to 0.1 mm.

12. The hydrodynamic bearing assembly of claim 7, wherein the lubricant pressure generating grooves are formed in the inner surface of the bearing, and the bearing defines a plurality of channels in an outer surface, each channel communicating with a corresponding lubricant pressure generating groove.

13. The cooling fan of claim 7, wherein the sleeve is U-shaped, and defines an end opening at the top end thereof with a diameter larger than that of the inner hole, an oil-retaining cover being mounted in the end opening of the sleeve and being mounted around the shaft.

14. The cooling fan of claim 13, wherein the cover has an upper portion with an inner diameter approximately the same as a diameter of a corresponding portion of the shaft, and a lower portion with an inner diameter larger than the diameter of the shaft, an oil-retaining space being formed among the shaft, the bearing, the sleeve and the cover.

15. The cooling fan of claim 14, wherein the sleeve forms a step in an outer surface thereof for mounting the stator thereon.
